(19) United States
(12) Patent Application Publication
(10) Pub. No.: US 2013/0277473 A1
(43) Pub. Date: Oct. 24, 2013

(54) SPICE GRINDERS

(71) Applicants: Patrick John Delbridge, Tokai (ZA); David Stephen Delbridge, Tokai (ZA)

(72) Inventors: Patrick John Delbridge, Tokai (ZA); David Stephen Delbridge, Tokai (ZA)

(21) Appl. No.: 13/990,350

(22) PCT Filed: Nov. 28, 2011
(86) PCT No.: PCT/IB2011/002865

§ 371 Date: Jul. 11, 2013

(30) Foreign Application Priority Data
Nov. 29, 2010 (ZA) 2010/08525

(51) Int. Cl. A47J 42/38

(52) U.S. Cl. CPC A47J 42/38
USPC 241/169.1

(57) ABSTRACT

The invention relates to a spice grinder which comprises a fixed component 12, a rotatable component 14, and a non-rotatable further component which is axially displaceable with respect to the rotatable component 14. An adjustment means 28 is provided for displacing the further component 13 axially with respect to the rotatable component 14. The further component 13 and the rotatable component 14 have grinding teeth (46 60 62) which face one another across a grinding gap. The further component 13 includes a first ramp having a camming surface 50 which co-operates with the camming surface 32 of a second ramp on the adjustment means 28. The camming surface 50 of the first ramp rides over the camming surface 32 of the second ramp as the adjustment means 28 is moved in the circumferential direction, thereby displacing the further component 13 axially with respect to the rotatable component 14 to adjust the position of the further component 13 with respect to the rotatable component, resulting in the width of the grinding gap being varied.

### FIELD OF THE INVENTION

This invention relates to spice grinders.

### BACKGROUND TO THE INVENTION

Grinders are known which comprise a fixed component and a rotatable component. The components carry teeth which face one another across a grinding gap. In simple grinders the gap is of fixed width. In more complex grinders the width of the grinding gap can be adjusted so that it is possible to grind to a fine powder or to a coarser powder.

The present invention seeks to provide an improved form of adjustable grinder.

### BRIEF DESCRIPTION OF THE INVENTION

According to one aspect of the present invention there is provided a spice grinder which comprises a fixed component, a rotatable component, a further component which is non-rotatable but is axially displaceable with respect to the rotatable component, and an adjustment means for displacing the further component axially with respect to the rotatable component; said further component and said rotatable component having grinding teeth which face one another across a grinding gap, said further component including a first ramp having a camming surface which co-operates with a camming surface of a second ramp on the adjustment means, said camming surface of the first ramp riding over the camming surface of the second ramp as the adjustment means is moved in the circumferential direction, thereby displacing the further component axially with respect to the rotatable component to adjust the position of the further component with respect to the rotatable component, resulting in the width of the grinding gap being varied.

Said adjustment means is preferably a ring positioned within a sleeve of the fixed component and having said second ramp on one of the axially facing surfaces thereof. The ring is free to move a limited distance in both directions about a centre position.

The ramp of the further component can be on one end surface of the further component.

Spring means can be provided for urging said camming surfaces into face-to-face contact. In one form the other end surface of the further component includes one or more springs which are between the further component and the rotatable component and urge said camming surfaces into face-to-face contact.

Said spring means can comprise inclined fingers each of which at one end can be attached to the remainder of the further component, the fingers extending towards said rotatable component. Alternatively, said inclined fingers can each at one end be moulded integrally with the remainder of the further component.

Preferably there is more than one first ramp and more than one second ramp. Where two or more ramps are provided they are spaced apart equidistantly around the further component and around the adjustment means.

### BRIEF DESCRIPTION OF THE DRAWINGS

For a better understanding of the present invention, and to show how the same may be carried into effect, reference will now be made, by way of example, to the accompanying drawings in which:

FIGS. 1 and 2 are pictorial views of a fixed component of a spice grinder;

FIGS. 3 and 4 are pictorial views of an adjustment means of the spice grinder;

FIGS. 5 and 6 are pictorial views of a displaceable further component of the spice grinder;

FIGS. 7 and 8 are pictorial views of a rotatable component of the spice grinder;

FIGS. 9 and 10 are pictorial views of a cap of the spice grinder;

FIG. 11 is a diametral section through the assembled grinder; and

FIG. 12 is an underneath plan view of the assembled grinder.

### DETAILED DESCRIPTION OF THE DRAWINGS

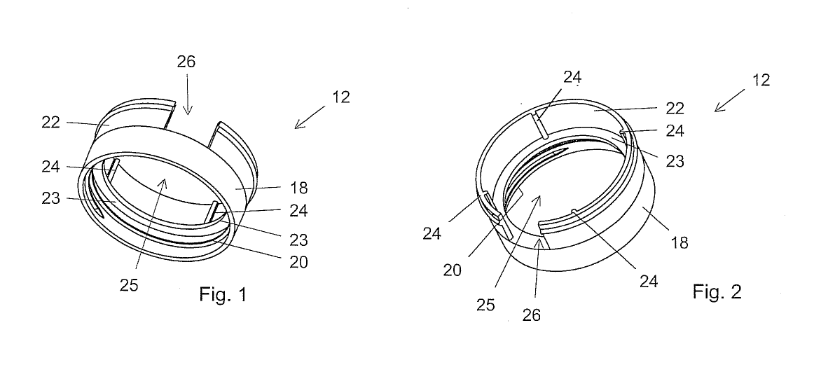

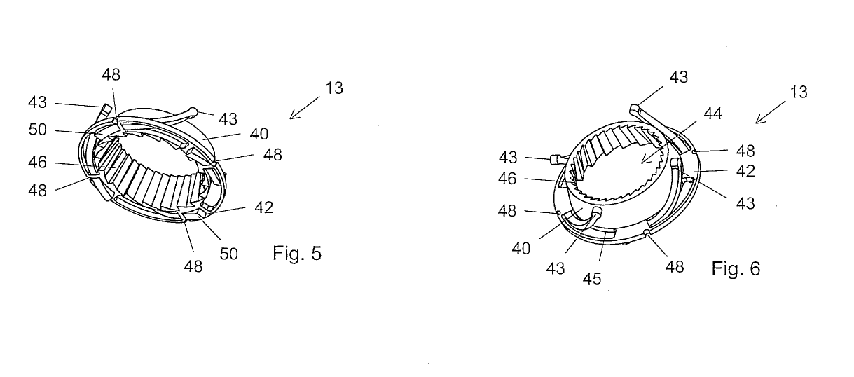

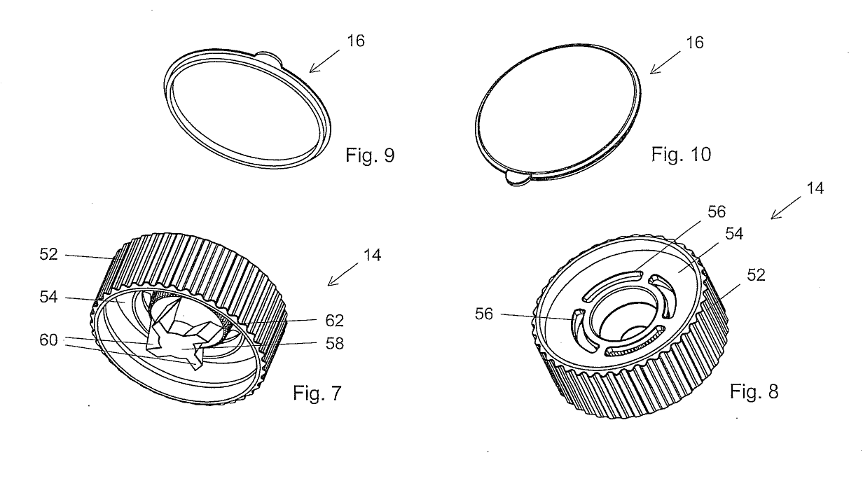

Referring to the drawings, the grinder illustrated comprises a fixed grinder component 12 (FIGS. 1 and 2) which screws onto the neck of a bottle (not shown). A further component 13 (FIGS. 5 and 6) is non-rotatable but is axially displaceable with respect to the component 12. A rotatable component 14 (FIGS. 7 and 8) of the grinder snap fits onto the fixed component 12 of the grinder and there is a closure cap 16 which fits onto the rotatable component 14.

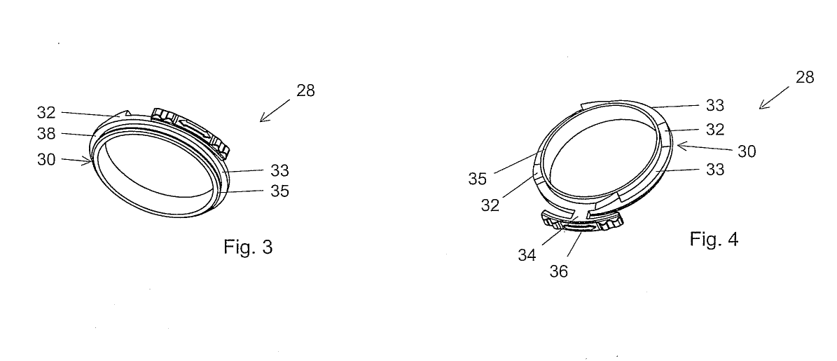

The fixed component 12 includes a skirt 18 and an upwardly extending sleeve 22. An annular flange 23 protrudes inwardly from an inner surface of the sleeve 22 to surround an opening 25, and forms the boundary between the skirt 18 and the sleeve 22. Above the flange 23 the sleeve 22 has four equally spaced longitudinally extending internal ribs 24. A notch 26 is provided in the sleeve 22 through which, after assembly of the grinder, adjustment means designated 28 and shown in FIGS. 3 and 4 protrudes. The notch 26 may be replaced by an elongate slot provided in the wall of the sleeve 22.

The adjustment means 28 is in the form of a ring 30. The upper face of the ring 30 includes four sloping camming surfaces 32. The ring 30 has a step in the external surface thereof thereby to provide a larger diameter upper part 33 and a smaller diameter lower part 35. A radial arm 34 having an arcuate part 36 attached thereto extends outwards from the ring 30. Alternatively, the radial arm 34 and the ring 30 can be integrally moulded.

The lower part 35 is configured to enable it to enter the opening 25, and the lower face 38 of the upper part 33 of the ring 30 is configured to be seated on the flange 23 within the sleeve 22 of the fixed component 12. The arm 34 of the adjustment means 28 is configured to extend through the notch 26 of the sleeve 22, with the arcuate part 36 lying outside the component 12.

The arcuate part 36 of the ring 30 in the assembled grinder can be gripped and slidingly adjusted by pushing it circumferentially as will be described hereinafter.

A detent (not shown) is provided on the radially inner face of the lower most region of the arcuate part 36 of the ring 30. The outer surface of the skirt 18 has at least three indentations (not shown) just below the opening 26 for receiving the detent thereby to hold the ring 30 in the position to which it has been adjusted.

The further component 13 (FIGS. 5 and 6) comprise a tapering sleeve 40 with a circumferentially extending web 42 protruding from the sleeve 40 at its lower end. The sleeve 40 has a conical bore 44 and teeth 46 protrude inwardly from the surface of the bore 44. Each tooth 46 is in the form of a rib which extends along the surface of the sleeve 40. The upper surface of the web 42 includes four equally spaced springs 43. Each spring is in the form of a finger which is moulded with the component 13. One end of each finger is integral with the remainder of the component 13. Below each finger there is a trough 45 for receiving the finger when the finger is pressed towards the web 42.

The web 42 includes four opposing notches 48, and the ribs 24 of the fixed component 12 fit into these notches 48. Four equally spaced ramps 50 with camming surfaces are provided on a lower surface of the web 42.

The rotatable component 14 (FIGS. 7 and 8) comprises an outer skirt 52 and a web 54 with openings 56 therein. A cone 58 forms the centre of the web 54. The cone 58 is closed at its lower end and joined, at its upper end, to the skirt 52 by the web 54. On the outside of the cone 58 there are four equally spaced protruding angled teeth 60. The number of angled teeth can be varied.

The angled teeth 60 break the pepper corns but do not grind them. They also push the corns towards the fine grinding zone, constituted by the smaller teeth 62 which are provided around the outer surface of the cone 58 at its wider end.

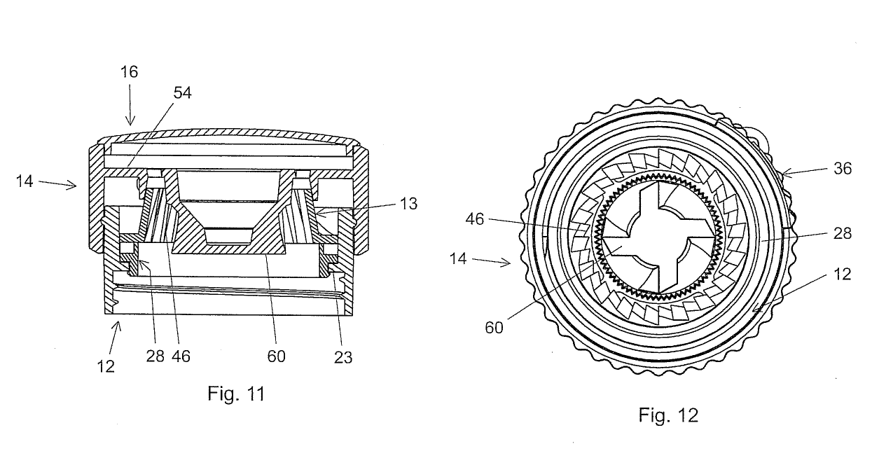

Referring now to FIGS. 11 and 12, the grinder is assembled by slipping the ring 30 into the sleeve 22 of the fixed component 12 until the lower face 38 of the upper part 33 of the ring 30 is seated on the flange 23 of the sleeve with the lower part 35 of the ring 30 extending into the opening 25. The arm 34 of the adjustment means 28 extends through the notch 26 of the sleeve 22 with the arcuate part 36 lying outside the component 12. The width of the notch 26 determines the distance through which the arm 34 can be moved.

The displaceable component 13 is pressed into the sleeve 22 so that the ribs 24 enter the notches 48 and the ramps 50 seat on the camming surfaces 32 of the ring 30. The rotatable component 14 is snap fitted over the fixed component 12, and the springs 43 of the displaceable component press against the under surface of the web 54. The grinder is now assembled and can be screwed onto the top of a filled bottle. The teeth 46 and 60 face one another across a breaking or cracking gap, and the teeth 46 and 62 face one another across a grinding gap.

To adjust the grinding gap the arcuate part 36 of the ring 30 is gripped and adjusted by moving it circumferentially. As the ring 30 turns, the camming surfaces of the ramps 50 of the displaceable component 13 “run up” or “run down” the camming surfaces 32 on the ring 30. This displaces the component 13 axially with respect to the fixed component 12 and towards or away from the rotatable component 14, thereby to vary the width of the grinding gap between the teeth 46 and 62 and hence the degree to which the corns are ground. The springs 43 provide a force which holds the ramps 50 against the camming surfaces 32 at all times so that the components maintain the position to which they have been adjusted.

When the grinder is inverted, peppercorns drop into the gap between the cone 58 and the sleeve 40. As the component 14 is rotated on the component 12, the teeth 46 and 60 break the peppercorns between them. The teeth 62 which co-operate with the parts of the teeth 46 which are at the smaller diameter end of the bore 44 act as a fine grinding structure. The fragments drop out of the grinder through the openings 56 in the web 54.

1. A spice grinder which comprises a fixed component, a rotatable component, a further component which is non-rotatable but is axially displaceable with respect to the rotatable component, and an adjustment means for displacing the further component axially with respect to the rotatable component; said further component and said rotatable component having grinding teeth which face one another across a grinding gap, said further component including a first ramp having a camming surface which co-operates with a camming surface of a second ramp on the adjustment means, said camming surface of the first ramp riding over the camming surface of the second ramp as the adjustment means is moved in the circumferential direction, thereby displacing the further component axially with respect to the rotatable component to adjust the position of the further component with respect to the rotatable component, resulting in the width of the grinding gap being varied.

2. A spice grinder as claimed in claim 1, wherein said adjustment means is a ring positioned within a sleeve of the fixed component and having said second ramp on one of the axially facing surfaces thereof.

3. A spice grinder as claimed in claim 1, wherein said ring is free to move a limited distance in both circumferential directions about a centre position.

4. A spice grinder as claimed in claim 1, wherein the ramp of the further component is on one end surface of the further component.

5. A spice grinder as claimed in claim 4, wherein spring means is provided for urging said camming surfaces into face-to-face contact.

6. A spice grinder as claimed in claim 5, wherein the other end surface of the further component includes one or more springs which are between the further component and the rotatable component and urge said camming surfaces into face-to-face contact.

7. A spice grinder as claimed in claim 6, wherein said spring means comprise inclined fingers.

8. A spice grinder as claimed in claim 7, wherein one end of each inclined finger is attached to the remainder of the further component and the fingers extend towards said rotatable component.

9. A spice grinder as claimed in claim 7, wherein one end of each inclined finger is integrally moulded with the remainder of the further component.

10. A spice grinder as claimed in claim 1, wherein said grinder includes more than one first ramp and more than one second ramp.

11. A grinder as claimed in claim 10, wherein said ramps are spaced apart equidistantly around the further component and around the adjustment means.
